(19) United States
(12) Patent Application Publication
(10) Pub. No.: US 2026/0316633 A1
(43) Pub. Date: Oct. 15, 2026

(54) SEAT ADJUSTMENT ASSEMBLY, VEHICLE SEAT AND METHOD FOR MANUFACTURING THE SEAT ADJUSTMENT ASSEMBLY

(71) Applicant: Faurecia Autositze GmbH, Hannover (DE)

(72) Inventors: Nicolas NAVATTE, Condé-sur-Noireau (FR); Emil RDZANEK, Józefoslaw (PL)

(73) Assignee: Faurecia Autositze GmbH, Hannover (DE)

(21) Appl. No.: 19/548,381

(22) Filed: Feb. 24, 2026

(30) Foreign Application Priority Data
Apr. 10, 2025 (DE) 10 2025 114 234.3

(51) Int. Cl. B60N 2/02; B60N 2/16

(52) U.S. Cl. CPC B60N 2/02258; B60N 2/1635

(57) ABSTRACT

The invention relates to a seat adjustment assembly including a frame part with mounting holes, an adjusting motor with a housing in which screw-in bores are introduced, and a carrier plate with through-holes, which is attached to the housing as well as to the frame part. The invention provides that the carrier plate is attached to both the housing and the frame part of the vehicle seat frame via a double screw having two threaded sections, where, to that end, the respective double screw penetrates through one of the through-holes in the carrier plate, and - a first threaded section of the respective double screw is screwed into one of the screw-in bores in the housing of the adjusting motor, and - a second threaded section of the same double screw projects through one of the mounting holes in the frame part and is secured therein.

This application claims priority of Germany Application No. DE 10 2025 114 234.3, filed Apr. 10, 2025, which is hereby incorporated herein by reference in its entirety.

The invention relates to a seat adjustment assembly for adjusting a vehicle seat according to the preamble of claim 1, as well as a vehicle seat including the seat adjustment assembly and a method for manufacturing the seat adjustment assembly.

A seat adjustment assembly of this type usually comprises an adjusting motor or, respectively, an adjusting pump serving, for example, to adjust the height of the vehicle seat. To that end, a pinion of the adjusting motor combs on a sprocket on a lever as part of a four-link (four-bar) linkage via which the vehicle seat is affixed to the vehicle floor in a manner pivoting in relation thereto. By rotating the pinion, the lever can be pivoted and therewith the vehicle seat can be adjusted in its height.

The attachment of the adjusting motor on the respective frame part, for example, a seat side part of a seat frame, happens by means of screws that engage through a carrier plate into a housing of the adjusting motor. The carrier plate in turn is attached to the respective frame part via separate attachment means, for example, also screws.

By way of example, this is described in the documents US10072649 B2, US10024392 B2, US11142094 B2, DE102017131095 A1, and US11180064 B2. Hereby, the publication DE 10 2017 131 095 A1 provides, in particular, for single screws to be threaded in with a self-tapping thread both into the carrier plate and into the housing of the adjusting motor.

A disadvantage in known seat adjustment assemblies is that these are complex to assemble, require many components for assembly, and, moreover, require a lot of space in the vehicle seat due to the shape of the components.

Thus, it is the object of the invention to provide a seat adjustment assembly as well as a vehicle seat that is simple to manufacture while requiring little material and space. A further object of the invention is to specify a method for such a simple way of manufacturing.

These tasks are solved by a seat adjustment assembly, a vehicle seat as well as a manufacturing method according to the independent claims. Preferred further developments are specified in the sub-claims.

Thus, what is provided is a seat adjustment assembly for adjusting a vehicle seat, in particular, for adjusting its height, comprising at least: - a frame part, for example, a seat side part with mounting holes, the frame part being part of a vehicle seat frame, for example, a seat frame of a seat part of the vehicle seat, additionally having a backrest part; - an adjusting motor or, respectively an adjusting pump having a housing, preferably made of plastic, and a pinion on the driven side, which can be actuated by operating the adjusting motor, for example, via an additional gearing mechanism in the adjusting motor, wherein screw-in bores are provided in the housing, and - a carrier plate having through-holes, preferably a flat or, respectively, planar carrier plate, having, for example, four through-holes in the housing corresponding to the screw-in bores, the carrier plate being attached to the housing of the adjusting motor as well as to the frame part in such a way that the carrier plate is located between the frame part and the housing of the adjusting motor. Hereby, the carrier plate is attached to both, the housing of the adjusting motor and the frame part of the vehicle seat frame, by means of at least one double screw, where, to that end, the respective double screw projecting through one of the through-holes in the carrier plate, and - a first threaded section of the respective double screw is screwed into one of the screw-in bores in the housing of the adjusting motor, and - a second threaded section of the same double screw projects through one of the mounting holes in the frame part and is secured therein, for example, by a nut being screwed on.

Hereby, the term double screw is to be understood, in comparison with a single screw, as meaning a cylindrical shaft with the two aforementioned threaded sections, having the same central axis and each preferably a different type of thread, each of which can be screwed into another bore/hole. In contrast hereto, a single screw only has one threaded section and a screw head at its end to allow one side of the screw to be screwed into a bore.

The invention already provides several advantages:

Since double screws are used as a means of attachment, fewer components are required. In addition, the through-holes can be used both for attaching onto the housing and for attaching onto the respective frame part so that the carrier plate can be designed simpler, in particular, merely with holes and in a flat or, respectively, planar design. This can save space and weight.

Moreover, such a flat carrier plate with the through-holes allows for a completely symmetric design so that a seat adjustment assembly can be realized both on the left and on the right side of the vehicle seat or, respectively, of the respective vehicle seat frame using and the same carrier plate in combination with the double screws. This increases flexibility and reduces efforts of assembly and storage. Also, there is no need to make complex adaptations to assembling processes, yet they are markedly simplified. Also, this can be adapted to changed components (adjusting motor) in a simple manner.

Preferably, it is further provided that the first threaded section of the at least one double screw has a grooving or self-tapping plastic thread , e.g., REMFORM or Delta-PT, by means of which the first threaded section is screwed into the respective screw-in bore of the housing, and/or the second threaded section of the at least one double screw has a metric thread, with which the second threaded section projects through the respective mounting hole, wherein a nut is screwed onto the metric thread onto the penetrating part of the second threaded section, which nut secures the second threaded section in the respective mounting hole.

Hereby, the term grooving or self-tapping thread is to be understood as meaning a thread that self-cuts, without pre-drilling, upon being screwed into the respective screw-in bore in the housing made of plastic. To that end, the first threaded section has, for example, a specially shaped, sharp-edged thread made or a hard and/or coated material, for example, steel, capable of engaging with the plastic or, respectively, displacing the plastic material so as to cut a precise thread. A self-tapping thread of this type bears the advantage that the assembling process is simplified because the screw-in bores of the housing do not have to be separately provided with a thread.

On the other hand, the metric thread allows a nut to be screwed onto the penetrating part in a simple manner so as to allow for a simple and secure attachment on the frame part usually made of metal.

Preferably, it is further provided that the at least one double screw has a, preferably unthreaded, center part in-between the two threaded sections which is radially elevated or raised in relation to the two threaded sections, e.g., in the manner of a Art radial rib or a radial elevation, preferably in such a way that the center part with its axially aligned surfaces rests against both the carrier plate and the frame part. This creates an additional supporting effect at the connecting points.

In addition, it is preferably further provided that an axial extension of the center part along the central axis of the respective double screw is dimensioned such that the carrier plate in the mounted state is held by the center part at a distance from the frame part to which the carrier plate is attached, comparable to a washer. Thus, advantageously, at the same time the center part may act as a spacer between the frame part and the carrier plate so that these do not rest flat against one another thereby improving the connection and the hold.

Preferably, it is further provided that the center part of the respective double screw is designed as a disk-shaped center part with planar (axial) surfaces lying parallel in relation to one another or as a conical shaped center part in the form of a conical shaped disk or a taper disk with a surface conical shaped in an axial direction and a planar surface. This way, different transitions are made possible, where the supporting effect can be improved in the case of a conical shaped structure, while a disk-shaped design reduces manufacturing cost.

Preferably, it is further provided that at least one of the through-holes in the carrier plate has a flanged collar with an annular or disk-shaped structure extending (disk-shaped) around the respective through hole, and/or at least one of the through-holes in the carrier plate has a chamfered, conical shaped collar with a chamfered edge extending around the respective through hole. Hereby, such collars support the double screw and render the through hole more stable. Moreover, the collar may contribute to securing the connection and to guarantee a good alignment of the double screw. The chamfered edge in a conical shaped collar makes sure that the center part is flush with the surface and the pressure distribution is improved.

Depending on the embodiment of the center part of the double screw, various shapes of the through-holes are possible, where these may even be combined with one another, i.e., chamfered through-holes and through-holes with a flanged collar or through-holes even without a collar can be combined within one carrier plate, for example, so as to receive double screws with different center parts or single screws (as explained below) with different screw heads (flat head, countersunk head).

Hereby, preferably, the through-holes are unthreaded, i.e., the double screws (or single screws) are not screwed into the carrier plate but merely penetrating the same. Thus, the hold is attained merely by the attachment of the respective threaded section to the housing or, respectively, to the frame part. Hereby, even the respective mounting hole on the frame part may be unthreaded, when only one attachment via the nuts is to be attained.

Preferably, it is further provided that the carrier plate is screwed onto the housing of the adjusting motor, in addition to via the at least one double screw, via at least one single screw with a screw head, e.g., a flat head or a countersunk head, depending on the embodiment of the collar of the respective through holes, and a plastic thread, where the single screw projects through the respective through hole in the carrier plate. Thus, the carrier plate can be attached on the housing even via a single screw, in which case the number of double screws will be reduced accordingly. Thus, depending on the application, in the case of four through-holes, for example, three double screws and one single screw up to only one double screw and three single screws can be used.

Preferably, it is further provided that in the carrier plate, in addition to the through-holes, at least one fitting hole is provided which is different in construction from the through-holes, preferably, smaller in diameter than the through-holes, where a positioning element, in particular, an unthreaded positioning element, for example, a positioning lug projecting away from the housing of the adjusting motor, is accommodated in the at least one fitting hole. This serves as a positioning aid upon assembly of the carrier plate on the housing so that this can be placed in the correct orientation and the through-holes will automatically align with the screw-in holes. Hereby, the shape of the fitting hole does not necessarily have to be round, where even a half or incomplete hole, for example, on the edge of the carrier plate, or a square hole or a slit-shaped hole may be referred to as a fitting hole in the sense of the application.

The invention further provides for a vehicle seat with a seat part and a backrest, the vehicle seat including a vehicle seat frame, for example, a seat frame of the seat part, and the vehicle seat frame a frame part, for example, a seat side part, where, further, the seat adjustment assembly for adjusting the vehicle seat, in particular, for adjusting the height of the vehicle seat, according to the invention is provided.

Preferably, hereby, the vehicle seat has front and rear levers attached to the seat frame torque-proof on both sides of cross tubes thereon, where the lower ends of the respective lever are pivoting connected to the vehicle floor (or a rail firmly attached to the floor). The levers form a four-link system, where pivoting of the levers causes a consistent height adjustment of the seat part and therewith the entire vehicle seat in relation to the vehicle floor. The four-link system formed by the levers are actuated via the pinion on the driven side of the adjusting motor, where the pinion combs on a toothed segment which is torque-proof connected to one of the levers, for example, to one of the rear levers.

Moreover, the invention provides for a method for manufacturing the seat adjustment assembly according to the invention, including at least the following steps:
- providing a frame part with mounting holes as a component of a vehicle seat frame, providing a housing of an adjusting motor, the housing having screw-in bores, as well as providing a carrier plate with through-holes;
- placing the provided carrier plate onto the provided housing in such a way that the through-holes in the carrier plate are aligned with the screw-in bores in the housing;
- inserting at least one double screw each into the respective through-hole in the carrier plate, and screwing a first threaded section of the respective double screw into the screw-in bore that is aligned with the through-hole for securing the carrier plate to the housing by means of the double screw, thereby providing a preassembled unit, comprising at least the housing as well as the placed-on and screwed-on carrier plate;
- placing the preassembled unit, comprising at least the housing as well as the screwed-on carrier plate, on the frame part in such a way that second threaded sections of the respective double screw, protruding away from the carrier plate, project through the mounting holes in the frame part; and
- screwing a nut onto that part of the second threaded section of the respective double screw which projects through the mounting holes.

As described earlier, this guarantees a simple assembly involving few components which also saves space. Preferably, it is further provided that, when placing the provided carrier plate onto the provided housing, at least one positioning element, for example, a positioning lug, projecting away from the housing of the adjusting motor, is positioned in at least one fitting hole in the carrier plate. This simplifies alignment of the carrier plate upon assembly.

Preferably, it is further provided that the first threaded sections of the respective double screw is screwed into the screw-in bore by means of a self-tapping introduction of a thread into the respective screw-in bore. Thus, it is not required to pre-drill or, respectively, introduce a thread in a preliminary step, reducing overall manufacturing complexity.

Preferably, it is further provided that the at least one double screw has a center part in-between the two threaded sections that is radially elevated in relation to the two threaded sections radial, where the first threaded sections of the respective double screw are screwed into the screw-in bore until the center part lies flush with the carrier plate, so as to secure the carrier plate via the double screw on the housing. Thus, the center part already serves to hold the the carrier plate so that the center part is secured upon placing the pre-assembled unit onto the frame part and can subsequently also serve as a spacer. Thus, this allows for dual use.

The invention is illustrated further by means of the accompanying drawings by means of an embodiment. It is shown in:

FIG. 1 a vehicle seat in a schematic side view with a seat adjustment assembly;

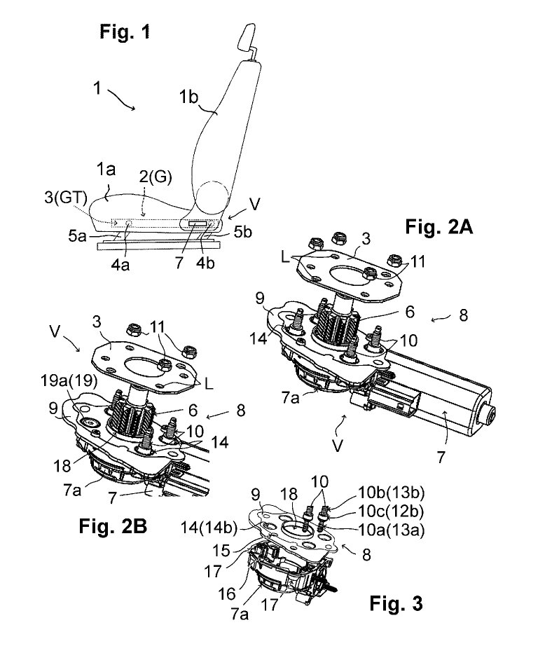

FIG. 2A, 2B a detail views of an adjusting motor of the seat adjustment assembly according to FIG. 1;

FIG. 3 a detail view of an attachment of a carrier plate on a housing of the adjusting motor via double screws;

FIG. 4A, 4B detail views of the double screws from FIG. 3 in different designs;

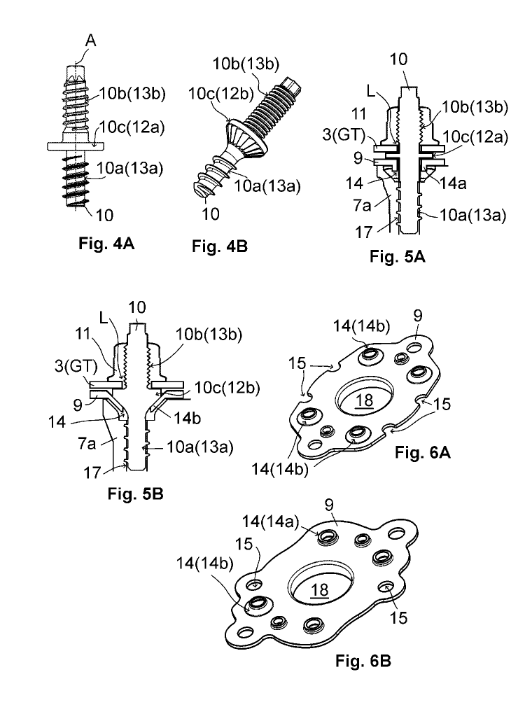

FIG. 5A, 5B section views of the double screws when screwed in; and

FIG. 6A, 6B carrier plates in different embodiments.

FIG. 1 shows schematically a vehicle seat 1 with a seat part 1a and a backrest part 1b pivotable in relation thereto. The seat part 1a has a seat frame 2 which in turn has seat side parts 3 connected with one another in a known manner via a front cross tube 4a and a rear cross tube 4b. To that end, the ends of the cross tubes 4a, 4b are each rotatably mounted on the seat side parts 3.

Front levers 5a and rear levers 5b are each torque-proof attached to both sides of the cross tubes 4a, 4b, where the lower ends of the respective levers 5a, 5b are pivotably connected with the vehicle floor (or a rail firmly affixed to the floor). The levers 5a, 5b form a four-link system, where pivoting the levers 5a, 5b or, respectively, rotation of the respective cross tube 4a, 4b causes a consistent height adjustment of the seat part 1a and therewith the entire vehicle seat 1 in relation to the vehicle floor.

This four-link mechanism formed by the levers 5a, 5b is actuated, as usual, via a pinion 6 on a driven side of an adjusting motor 7 (adjusting pump), in particular, a, electric gear motor, as shown in FIGS. 2A and 2B. Hereby, as is well known in the art, the pinion 6 combs as on a toothed segment which is torque-proof connection to one of the levers 5a, 5b, for example, to one of the rear levers 5b. Thus, rotating the pinions 6 also pivots the respective lever 5a, 5b to which the toothed segment is attached in the one or the other direction about the lower bearing points on the vehicle floor. This pivoting movement translates via the cross tubes 4a, 4b and the seat side parts 3 to all levers 5a, 5b so that the vehicle seat 1 in its entirety is consistently adjusted upwards or downwards.

As shown in FIGS. 2A and 2B, the adjusting motor 7 is connected via a connection system 8 to one of the seat side parts 3 which is adjacent to the lever 5a, 5b with the toothed segment to be driven. In the FIGS. 2A and 2B, the seat side part 3 is shown merely in parts, i.e., in reality, it is of larger dimensions and has a corresponding shape. As an interface between the adjusting motor 7 and the respective seat side part 3 the connection system 8 is provided with a carrier plate 9 as well as double screws 10 and nuts 11 corresponding there with. In the FIGS. 2A, 2B, 3, the carrier plate 9 is depicted merely in exemplary fashion in terms of dimensions and shape, where the carrier plate 9 is preferably designed as a flat or, respectively, planar component.

The carrier plate 9 is place on a housing 7a of the adjusting motor 7, as shown in FIG. 3, and affixed thereto via the double screws 10, as will be explained in more detail in the following. This creates a seat adjustment assembly V comprising at least: the adjusting motor 7 with the housing 7a which is preferably made of plastic, the carrier plate 9, the respective seat side part 3 as well as the double screws 10 and nuts 11. As such the seat adjustment assembly V is adapted to adjust the height of the seat part 1a or, respectively, the entire vehicle seat 1 by suitably controlling the adjusting motor 7.

As shown in detail in FIGS. 4A and 4B, the double screws 10 each have a first threaded section 10a and a second threaded section 10b having the same central axis A and each a different type of thread. A center part 10c is provided in-between the two threaded sections 10a, 10b which part is designed, in the case of the double screw 10 in FIG. 4A, as a disk-shaped center part 12a with planar surfaces lying parallel to one another, and in the double screw 10 in FIG. 4B, as a conical shaped center part 12b in the form of a conical shaped disk or a bevel washer with a conical shaped surface and a planar surface.

In both designs of the double screw the first threaded section 10a has a plastic thread 13a (e.g., REMFORM or Delta-PT) 10 as the type of thread, i.e., the thread in the first threaded section 10a is designed such that the double screw 10 can be screwed into the plastic material of the housing 7a of the adjusting motor 7 via this first threaded section 10a, as shown, by way of example, in FIG. 5A (disk-shaped center part 12a) and FIG. 5B (conical shaped center part 12b) each in a sectional view. The plastic thread 13a in the first threaded section 10a is preferably designed as a grooving or, respectively, self-tapping thread which self-taps upon being screwed into the plastic of the housing 7a without pre-drilling. In both embodiments of the double screw 10 the threaded section 10b has a metric thread 13b as the type of thread which allows for a nut 11 to be screwed onto it.

Thus, the double screws 10 represented in FIGS. 4A and 4B differ merely in the center part 10c; 12a, 12b between the two threaded sections 10a, 10b. The carrier plate 9 is correspondingly adapted to the different designs of the center part 10c; 12a, 12b, as shown in FIGS. 5A and 5B as well as in the FIGS. 6A and 6B.

Thus, in all embodiments shown, the planar carrier plate 9 has four through-holes 14 which have, in accordance with the design of the center part 10c; 12a, 12b, either a flanged collar 14a with a widened, annular structure that extends around the respective through hole 14, or a chamfered, conical shaped collar 14b with a chamfered edge around the respective through hole 14. In FIG. 6A, a carrier plate 9 with four through-holes 14 having a flanged collar 14a is provided. In FIG. 6B, however, a through hole 14 with a flanged collar 14a and three through-holes 14 with a chamfered collar 14b are provided. Hereby, the arrangement of the through-holes 14 on the carrier plate 9 is symmetrical so that the same carrier plate 9, depending on the application, can be utilized both on the seat side part 3 on the left and on the right side of the seat frame 2 of the vehicle seat 1. Even the shape may be symmetrical accordingly, as shown in FIGS. 6A and 6B, by way of example.

In addition to the through-holes 14 serving to accommodate the double screws 10, at least one fitting hole 15 or guide hole or, respectively lug hole is introduced in the carrier plate 9. This is preferably a little smaller in diameter than the through-holes 14 and serves to accommodate at least one unthreaded positioning element 16, for example, a positioning lug, which projects away from the housing 7a of the adjusting motor 7, as shown in FIGS. 2A, 2B and 3. This allows for exact positioning and a secure hold of the carrier plate 9 for assembly.

Thus, initially, the carrier plate 9 can be placed on the housing 7a such that the at least one positioning element 16 engages with the at least one respectively associated fitting hole 15 in the carrier plate 9. Thus, the carrier plate 9 can be placed on the housing 7a quickly and at the exact position. In this position the through-holes 14 in the carrier plate 9 align with screw-in bores 17 in the housing 7a. In this position the first threaded section 10a of the double screws 10, in which the plastic thread 13a is located, can be inserted through the through-holes 14 and screwed into the screw-in bores 17, preferably employing a grooving or, respectively self-tapping introduction of a thread into the respective screw-in bore 17.

The act of screwing will then be carried out until the respective center part 10c; 12a, 12b lies flush with the carrier plate 9, where the conical shaped center part 12b in the respective embodiment will come to rest against the flanged collar 14a. The double screw 10 is then tightened accordingly so that the carrier plate 9 sits firmly on the housing 7a and is secured by the double screws 10. This creates a pre-assembled unit consisting of the housing 7a or, respectively, the adjusting motor 7 as well as the applied and screwed-on carrier plate 9.

Also, disposed centrally in the carrier plate 9 is a pinion-receiving hole 18, for example, also with a flanged collar, so that the pinion 6 can be guided through this upon assembly of the pre-assembled unit and can comb on the toothed segment after assembly of this pre-assembled unit.

Subsequently, this pre-assembled unit consisting of the housing 7a or, respectively, the adjusting motor 7 as well as the screwed-on carrier plate 9 and the projecting second threaded sections 10b of the double screws 10 is plugged onto the respective seat side part 3 so that the second threaded sections 10b of the double screws 10 penetrate through mounting holes L in the seat side part 3, where, subsequently, the nuts 11 are screwed onto the metric thread 13b on the projecting part, as indicated in FIGS. 2A and 2B. This secures the adjusting motor 7 with the housing 7a via the connection system 8 on the seat side part 3 thereby creating the seat adjustment assembly V. owing to the center parts 10c; 12a, 12b, which are made with a corresponding thickness, the seat side part 3 is held at a distance to the carrier plate 9, i.e., the carrier plate 9 does not lie flush with the seat side part 3 in the embodiments shown.

As can be seen in FIG. 2B, it is an option, depending on the embodiment and application, to screw in only three double screws 10 as described above, and a single screw 19 having a screw head 19a (flat head or countersunk head, depending on the design of the collar 14a, 14b) and a plastic thread 13a is screwed into the remaining through hole 14, by means of which screw the carrier plate 9 is additionally secured on the housing 7a. Then, the attachment on the seat side part 3 happens merely via three double screws 10. In further embodiments, not shown, even two double screws 10 and two single screws 19 or one double screw 10 and three single screws 19 may be utilized to affix the adjusting motor 7 to the seat side part 3 via the carrier plate 9.

In general terms, the seat adjustment assembly V can be created, depending on the application, on any frame parts GT of a vehicle seat frame G, where, merely by way of example, an embodiment with the seat side part 3 as the frame part GT of a seat frame 2 as the vehicle seat frame G is described by means of the Figures to adjust the height of the vehicle seat 1.

The following numbered clauses include embodiments that are con-templated and non-limiting:

Clause 1: A seat adjustment assembly for adjusting a vehicle seat, at least comprising:
a frame part with mounting holes, as a component of a vehicle seat frame;
an adjusting motor having a housing, preferably made of plastic, and a pinion on the driven side, which can be actuated by operating the adjusting motor, wherein screw-in bores are provided in the housing, and
a carrier plate having through-holes, the carrier plate being attached to the housing of the adjusting motor and to the frame part in such a way that the carrier plate is disposed between the frame part and the housing of the adjusting motor, characterized in that the carrier plate is attached to both the housing of the adjusting motor and the frame part of the vehicle seat frame, by means of at least one double screw having two threaded sections, the respective double screw penetrating through one of the through-holes in the carrier plate, and
a first threaded section of the respective double screw is screwed into one of the screw-in bores in the housing of the adjusting motor, and
a second threaded section of the same double screw projects through one of the mounting holes in the frame part and is secured therein.

Clause 2: A seat adjustment assembly according to clause 1, characterized in that
the first threaded section of the at least one double screw has a grooving or self-tapping plastic thread, e.g., REMFORM or Delta-PT, which is adapted to cut itself into the respective screw-in bore in the housing without pre-drilling, and/or
the second threaded section of the at least one double screw has a metric thread, with which the second threaded section projects through the respective mounting hole, wherein a nut is screwed onto the metric thread on the projecting part of the second threaded section, which nut secures the second threaded section in the respective mounting hole.

Clause 3: A seat adjustment assembly according to clause 1 or clause 2, characterized in that the at least one double screw has a central part between the two threaded sections which is radially extended in relation to the two threaded sections, preferably such that the center part rests with its axially aligned surfaces both on the carrier plate and on the frame part.

Clause 4: A seat adjustment assembly according to clause 3, characterized in that an axial extension of the center part along the central axis of the respective double screw is dimensioned such that the carrier plate in the mounted state is held by the center part at a distance from the frame part to which the carrier plate is attached.

Clause 5: A seat adjustment assembly according to clause 3 or clause 4, characterized in that the center part of the respective double screw is designed as a disk-shaped center part or as a conical shaped center part.

Clause 6: A seat adjustment assembly according to one of the above clauses, characterized in that at least one of the through-holes in the carrier plate has a flanged collar with an annular structure extending around the respective through hole, and/or at least one of the through-holes in the carrier plate has a chamfered, conical shaped collar with a chamfered edge extending around the respective through hole.

Clause 7: A seat adjustment assembly according to one of the above clauses, characterized in that the carrier plate is screwed onto the housing of the adjusting motor via at least one double screw and additionally via at least one single screw having a screw head and a plastic thread, with the single screw passing through the respective through hole in the carrier plate.

Clause 8: A seat adjustment assembly according to one of the above clauses, characterized in that at least one fitting hole is made in the carrier plate in addition to the through-holes, which preferably differs from the through-holes in construction, the at least one fitting hole accommodating a positioning element, for example, a positioning lug, which projects away from the housing of the adjusting motor.

Clause 9: A seat adjustment assembly according to one of the above clauses, characterized in that the frame part is a seat side part of a seat frame of a seat part as a vehicle seat frame.

Clause 10: A vehicle seat including a seat part and a backrest, the vehicle seat comprising a vehicle seat frame, for example, a seat frame of the seat part, and the vehicle seat frame a frame part, for example, a seat side part, where, further, a seat adjustment assembly is provided for adjusting the vehicle seat, in particular, for height adjusting the vehicle seat, according to one of the above clauses.

Clause 11: A method for producing a seat adjustment assembly according to one of the clauses 1 to 9, any other suitable clause, or any combination of suitable clauses, comprising at least the following steps:
providing a frame part with mounting holes as a component of a vehicle seat frame, providing a housing of an adjusting motor, the housing having screw-in bores, and providing a carrier plate with through-holes;
placing the provided carrier plate on the provided housing in such a way that the through-holes in the carrier plate are aligned with the screw-in bores in the housing;
inserting at least one double screw into the respective through-hole in the carrier plate, and screwing a first threaded section of the respective double screw into the screw-in bore that is aligned with the through-hole, for securing the carrier plate to the housing by means of the double screw;
placing the preassembled unit, comprising at least the housing and the screwed-on carrier plate, on the frame part in such a way that second threaded sections of the respective double screw, protruding away from the carrier plate, project through the mounting holes in the frame part; and
screwing a nut onto that part of the second threaded section of the respective double screw which projects through the mounting holes.

Clause 12: The method according to clause 11, any other suitable clause, or any combination of suitable clauses, wherein, when placing the provided carrier plate on the provided housing, at least one positioning element, for example a positioning lug, which projects from the housing of the adjusting motor, is positioned in at least one fitting hole in the carrier plate.

Clause 13: The method according to clause 11 or 12, any other suitable clause, or any combination of suitable clauses, wherein the first threaded section of the respective double screw is screwed into the screw-in bore by a self-cutting introduction of a thread into the respective screw-in bore.

Clause 14: The method according to one of the clauses 11 to 13, any other suitable clause, or any combination of suitable clauses, wherein at least one double screw has a middle part between the two threaded sections, which middle part is radially extended with respect to the two threaded sections, the first threaded section of the respective double screw being screwed into the screw-in bore until the central part rests against the carrier plate in order to secure the carrier plate to the housing by means of the double screw.

### LIST OF REFERENCE NUMERALS

1 vehicle seat

1a seat part

1b backrest part

2 seat frame

3 seat side part

4a front cross tube

4b rear cross tube

5a front lever

5b rear lever

6 pinion

7 adjusting motor

7a housing of the adjusting motor 7

8 connection system

9 carrier plate

10 double screw

10a first threaded section of the double screw 10

10b second threaded section of the double screw 10

10c center part of the double screw 10

11 nut

12a disk-shaped center part

12b conical shaped center part

13a plastic thread

13b metric thread

14 through hole

14a flanged collar

14b conical shaped collar

15 fitting hole

16 positioning element

17 screw-in bore

18 pinion-receiving hole

19 single screw

19a screw head

A central axis

G vehicle seat frame

GT frame part

L mounting hole

V seat adjustment assembly

1. A seat adjustment assembly for adjusting a vehicle seat, at least comprising:
a frame part with mounting holes, as a component of a vehicle seat frame;
an adjusting motor having a housing and a pinion on the driven side, which can be actuated by operating the adjusting motor, wherein screw-in bores are provided in the housing, and
a carrier plate having through-holes, the carrier plate being attached to the housing of the adjusting motor and to the frame part in such a way that the carrier plate is disposed between the frame part and the housing of the adjusting motor, wherein
the carrier plate is attached to both the housing of the adjusting motor and the frame part of the vehicle seat frame, by means of at least one double screw having two threaded sections, the respective double screw penetrating through one of the through-holes in the carrier plate, and
a first threaded section of the respective double screw is screwed into one of the screw-in bores in the housing of the adjusting motor, and
a second threaded section of the same double screw projects through one of the mounting holes in the frame part and is secured therein.

2. The seat adjustment assembly according to claim 1, wherein the adjusting motor having a housing made of plastic.

3. The seat adjustment assembly according to claim 1, wherein
the first threaded section of the at least one double screw has a grooving or self-tapping plastic thread, which is adapted to cut itself into the respective screw-in bore in the housing without pre-drilling, and/or
the second threaded section of the at least one double screw has a metric thread, with which the second threaded section projects through the respective mounting hole, wherein a nut is screwed onto the metric thread on the projecting part of the second threaded section, which nut secures the second threaded section in the respective mounting hole.

4. The seat adjustment assembly according to claim 3, wherein the first threaded section of the at least one double screw has a REMFORM or Delta-PT thread as a grooving or self-tapping plastic thread.

5. The seat adjustment assembly according to claim 1, wherein the at least one double screw has a central part between the two threaded sections which is radially extended in relation to the two threaded sections.

6. The seat adjustment assembly according to claim 5, wherein the central part rests with its axially aligned surfaces both on the carrier plate and on the frame part.

7. The seat adjustment assembly according to claim 5, wherein an axial extension of the center part along the central axis of the respective double screw is dimensioned such that the carrier plate in the mounted state is held by the center part at a distance from the frame part to which the carrier plate is attached.

8. The seat adjustment assembly according to claim 5, wherein the center part of the respective double screw is designed as a disk-shaped center part or as a conical shaped center part.

9. The seat adjustment assembly according to claim 1, characterized in that at least one of the through-holes in the carrier plate has a flanged collar with an annular structure extending around the respective through hole, and/or at least one of the through-holes in the carrier plate has a chamfered, conical shaped collar with a chamfered edge extending around the respective through hole.

10. The seat adjustment assembly according to claim 1, wherein the carrier plate is screwed onto the housing of the adjusting motor via at least one double screw and additionally via at least one single screw having a screw head and a plastic thread, with the single screw passing through the respective through hole in the carrier plate.

11. The seat adjustment assembly according to claim 1, wherein at least one fitting hole is made in the carrier plate in addition to the through-holes, which preferably differs from the through-holes in construction, the at least one fitting hole accommodating a positioning element, for example, a positioning lug, which projects away from the housing of the adjusting motor.

12. The seat adjustment assembly according to claim 1, wherein the frame part is a seat side part of a seat frame of a seat part as a vehicle seat frame.

13. A vehicle seat having a seat part and a backrest, the vehicle seat comprising a vehicle seat frame, for example, a seat frame of the seat part, and the vehicle seat frame having a frame part, for example, a seat side part, where, further, a seat adjustment assembly is provided for adjusting the vehicle seat, in particular, for height adjusting the vehicle seat, according to claim 1.
